(19) United States
(12) Patent Application Publication
(10) Pub. No.: US 2026/0253991 A1
(43) Pub. Date: Aug. 27, 2026

(54) LARGE CYLINDRICAL SODIUM-ION BATTERY CELL ENERGY STORAGE DEVICE

(71) Applicant: Power Ahead Group, Inc, Boulder, CO (US)

(72) Inventors: Yeling XU, Shanghai (CN); Huiyan LI, Shanghai (CN)

(73) Assignee: Power Ahead Group, Inc, Boulder, CO (US)

(21) Appl. No.: 19/174,966

(22) Filed: Apr. 10, 2025

(30) Foreign Application Priority Data
Feb. 21, 2025 (CN) 202510201056.1

(51) Int. Cl. H01M 10/6566; H01M 10/054; H01M 10/613; H01M 10/643; H01M 10/6551; H01M 50/213; H01M 50/264; H01M 50/291; H01M 50/30

(52) U.S. Cl. CPC H01M 10/6566; H01M 10/054; H01M 10/613; H01M 10/643; H01M 10/6551; H01M 50/213; H01M 50/264; H01M 50/291; H01M 50/30

(57) ABSTRACT

A large cylindrical sodium-ion battery cell energy storage device includes a box body, battery cells, and an air cooling mechanism, and further including an upper shell, a lower shell, positioning sleeves, clamping assemblies, and flow guide assemblies. By arranging the clamping assemblies and the flow guide assemblies, heat generated by the battery cells is transferred to the flow guide assemblies, thereby increasing the heat dissipation area and improving the heat dissipation effect; and an air duct through which cooling airflow flows is more finely separated by the flow guide assemblies, so as to form a "rectifier"-like effect, thereby avoiding the situation that the cooling airflow forms turbulence among the densely arranged battery cells to affect the heat dissipation effect, further ensuring the heat dissipation effect of the cooling airflow on the battery cells, and further ensuring the service life of the battery cells.

### CROSS REFERENCE TO THE RELATED APPLICATIONS

This application is based upon and claims priority to Chinese Patent Application No. 202510201056.1, filed on February 21, 2025, the entire contents of which are incorporated herein by reference.

### TECHNICAL FIELD

The present disclosure relates to the technical field of sodium-ion battery cell energy storage, and in particular, to a large cylindrical sodium-ion battery cell energy storage device.

### BACKGROUND

Battery cell energy storage is a technology that converts electrical energy into chemical energy through an electrochemical reaction for storage, and then reconverts the chemical energy back into the electrical energy when needed. Cylindrical battery cell energy storage is one of the main forms of the battery cell energy storage, and a sodium-ion battery cell is mainly made of a polyanionic material. Due to the unique structure, the polyanionic material enables the battery cell to have the characteristics of high energy density, long cycle life, and high safety, so that it is widely used in household energy storage, portable energy storage, industrial and commercial energy storage, and other fields.

During the process of charging or discharging a sodium-ion cylindrical battery cell energy storage device, the current inside the battery cell generates Joule heat, that is, the electrical energy is converted into the thermal energy. Especially in a case of overcharging or over-discharging, some side reactions, such as electrolyte decomposition, may occur inside the battery cell. These situations may also release a significant amount of heat. If the heat cannot be dissipated in time, the local temperature rise is easily caused, so that local hot spots are formed on a surface of the battery cell. However, these hot spots often accelerate the aging and performance degradation of materials such as polyanionic material and even cause thermal runaway. In addition, in densely arranged cylindrical battery cells, due to a smaller gap between the battery cells, a heat dissipation channel is limited, which easily forms a "heat island effect", so that the heat in a middle area is more difficult to dissipate. In order to dissipate the heat between the battery cells in time, in the related art, a fan and other devices are often used to provide forced airflow, and the heat between the battery cells is removed through fast-flowing airflow. For example, in a heat dissipation apparatus for a cylindrical battery cell lithium battery with Publication No. of CN214013019U in the related art, cooling is achieved by enabling the forced airflow to pass through the gap between the plurality of cylindrical battery cells and remove the heat from the surface of the battery cell through the cooperation of air cooling and water cooling.

However, due to the dense arrangement of the battery cells and the complexity of fluid flow, when the airflow is blown between the battery cells, turbulence is likely to form, which leads to uneven fluid flow, thereby affecting the effect of air cooling and further aggravating the accumulation of local heat. This situation is likely to accelerate the aging of materials such as polyanionic material, thereby affecting the normal use of the battery cell and even causing thermal runaway.

Therefore, a large cylindrical sodium-ion battery cell energy storage device is proposed.

### SUMMARY

An objective of the present disclosure is to provide a large cylindrical sodium-ion battery cell energy storage device, which solves the problem that when battery cells generate heat during the charging and discharging processes, the heat in a middle area is difficult to dissipate due to the dense arrangement of the cylindrical battery cells. The heat of the battery cells is transferred to flow guide assemblies through clamping assemblies, the heat dissipation area is expanded using the flow guide assemblies, and adjacent groups of flow guide assemblies abut against each other to separate an air duct through which cooling airflow flows, so as to form a ''rectifier''-like effect, thereby avoiding the formation of turbulence, ensuring the heat dissipation effect of the cooling airflow, and prolonging the service life of the battery cell.

In order to achieve the above objective, the present disclosure provides the following technical solution.

A large cylindrical sodium-ion battery cell energy storage device includes a box body, battery cells, and an air cooling mechanism, and further includes an upper shell, a lower shell, positioning sleeves, clamping assemblies, and flow guide assemblies. The upper shell and the lower shell are both arranged in the box body. The upper shell is provided with a plurality of upper mounting grooves, and the lower shell is provided with a plurality of lower mounting grooves. An upper air vent is formed among every four of the upper mounting grooves, a lower air vent is formed among every four of the lower mounting grooves, and an air duct through which cooling airflow flows is formed between the lower air vent and the upper air vent. The plurality of battery cells are arranged between the upper shell and the lower shell. The positioning sleeves are arranged between the upper shell and the lower shell. The plurality of clamping assemblies are connected to the positioning sleeve. The flow guide assembly is connected to the clamping assembly. The battery cell is inserted into the positioning sleeve and clamped by the clamping assemblies. The plurality of clamping assemblies move in a direction away from a central axis of the positioning sleeve, and drive the flow guide assemblies to move into an air duct formed between the upper air vent and the lower air vent. The adjacent flow guide assemblies abut against each other to separate the air duct into a plurality of channels.

Through the above solution, after the battery cell is inserted into the positioning sleeve, the clamping assemblies provide a certain degree of clamping force for the battery cell, thereby improving the stability of the installation of the battery cell. On the other hand, the clamping assembly can transfer the heat generated by the battery cell to the flow guide assembly, and the heat dissipation area is increased through the flow guide assembly to improve the heat dissipation effect. In addition, the flow guide assembly is directly exposed to the air duct through which the cooling airflow flows under the extrusion of the battery cell, so that the cooling air directly acts on the surface of the flow guide assembly to improve the heat dissipation effect. The adjacent flow guide assemblies abut against each other to separate the air duct into the plurality of smaller channels, so as to form a ''rectifier''-like effect to avoid the formation of turbulence, which not only ensures the heat dissipation effect, but also can compress the cross-sectional area of a fluid flow path, thereby accelerating the fluid flow, further improving the heat dissipation effect, ensuring the service life and performance of materials such as polyanionic material, and further ensuring the service life of the battery cell.

Preferably, the lower air vent is located above the air cooling mechanism, and an upper side edge of the upper air vent is provided with an arc chamfer.

Through the above solution, due to the principle of natural rise of hot air, a certain temperature difference may occur on the surface of the battery cell, that is, the temperature of the upper part is higher than that of the lower part. Therefore, the air cooling mechanism is of an air extraction type, which can draw airflow with lower external temperature from the upper air vent, then flow through the air duct between the plurality of groups of battery cells, and finally be discharged from the lower air vent, so that the cooling airflow first cools the area with higher temperature, thereby ensuring the uniformity of the surface temperature of the battery cell, and at the same time accelerating the outflow of the hot air between the battery cells. The arrangement of the arc chamber at the edge of the upper air vent can enable the airflow to flow more smoothly.

Preferably, a side wall of the positioning sleeve is provided with a plurality of sliding grooves, the clamping assembly is connected to the sliding groove, and the clamping assembly includes a clamping plate, a limiting rod, and a compression spring. The limiting rod is connected to the positioning sleeve, the clamping plate is connected to the limiting rod, the compression spring is sleeved on the limiting rod and both ends thereof are respectively connected to the clamping plate and the positioning sleeve, and an upper end of the clamping plate is provided with an inclined surface.

Through the above solution, during the process of inserting the battery cell into the positioning sleeve, the battery cell pushes the clamping plate to move through the inclined surface at the upper end of the clamping plate. At the same time, the clamping plate provides a certain clamping force for the battery cell under the action of the compression spring, thereby ensuring the stability of the installation of the battery cell and improving the use safety of the battery cell.

Preferably, the clamping plate is an arc plate, and the clamping plate is made of a metal material with a high thermal conductivity.

Through the above solution, the shape of the clamping plate can adapt well to an arc surface of a side surface of the battery cell, thereby maximizing the contact area, improving the heat dissipation effect, ensuring the operating temperature of the battery cell, and reducing the risk of thermal runaway. At the same time, the shape of the clamping plate enables the clamping plate to provide sufficient contact pressure for the battery cell, thereby ensuring the stability of the installation of the battery cell.

Preferably, the side wall of the positioning sleeve is provided with a plurality of through grooves, and the through groove is located between every two sliding grooves.

Through the above solution, the communication space between the inside and the outside of the positioning sleeve is increased by the through groove, and the exposed surface area of the side wall of the battery cell is increased, thereby ensuring the heat dissipation effect.

Preferably, the flow guide assembly includes fins. The plurality of fins are connected to the clamping plate, and the fins are made of a metal material with a high thermal conductivity.

Through the above solution, the heat dissipation area is increased by the fins, and the fins are made of the same material as the clamping plate, both being the metal materials with the high thermal conductivity, so that the fins can absorb the heat of the clamping plate well, and the fins are located in the flow path of the cooling airflow so as to dissipate the surface heat in time and ensure the heat dissipation effect thereof.

Preferably, ends of the fins away from the clamping plate are all provided with inclined surfaces, and the ends of the fins between the adjacent battery cells cooperate with each other.

Through the above solution, after the battery cells are inserted, the adjacent groups of fins abut against each other, so that the air duct through which the cooling airflow flows is separated into the plurality of channels with smaller cross-sectional areas, so as to form a ''rectifier'' like effect, thereby avoiding the formation of turbulence, enabling the cooling airflow to form the more stable airflow between the battery cells, and ensuring the heat dissipation effect of the cooling airflow on the battery cells. After the plurality of fins abut against each other, the cross-sectional areas of the plurality of channels after separation are reduced, thereby compressing the cross-sectional area of the fluid flow path, accelerating the fluid flow, improving the heat dissipation effect, and ensuring the service life of the battery cell.

Preferably, the flow guide assembly further includes filling layers. The filling layers coat the ends of the fins, and the filling layers are made of a flexible material.

Through the above solution, hard contact between the adjacent groups of fins is avoided, thereby reducing the wear and prolonging the service life. In addition, the flexible material enables the fins to be tightly attached, so that there is no gap at an abutment position between the fins, thereby enabling the gas flow to be more stable.

Preferably, the upper shell is provided with a plurality of air channels, both ends of the air channel are respectively provided with an air port 1 and an air port 2, the air port 1 is located at the upper air vent, an opening of the air port 1 is inclined downward, the air port 2 is located at the upper mounting groove, and an orientation of the air port 2 is horizontal.

In the densely arranged cylindrical battery cells, due to the cylindrical shape and the characteristics of gas flow, triangular areas, referred to as "triangular blind areas", may be formed at the top or bottom of the battery cells, as shown in FIG. 7. Since the heat dissipation channels in these areas are limited and the cooling airflow is difficult to reach, local overheating is easily caused. Through the above solution, the orientation of the air port 2 can conveniently guide the airflow in the area where the triangular blind area is located into the air channel, while the orientation of the air port 1 can conveniently guide the airflow into the air duct between the upper air vent and the lower air vent, thereby accelerating the gas flow in the area where the triangular blind area is located, avoiding local overheating of the area where the triangular blind area is located, further ensuring the heat dissipation effect of the battery cell, and prolonging the service life of the battery cell.

Preferably, the positioning sleeve is provided with a plurality of through holes, opening positions of the through holes correspond to the fins, a plurality of plugs are arranged below the upper shell, and ends of the plugs are made of a rubber material.

Through the above solution, after the battery cells are installed, the upper shell needs to cover the battery cells. At this time, the plugs below the upper shell pass through the through holes and abut against the surfaces of the fins, and the rubber material at the ends thereof increase the friction with the fins, thereby ensuring the stability of the fin positions.

Compared with the related art, the present disclosure has the following beneficial effects.

According to the large cylindrical sodium-ion battery cell energy storage device of the present disclosure, by arranging the clamping assemblies and the flow guide assemblies, the heat generated by the battery cells is transferred to the flow guide assemblies, thereby increasing the heat dissipation area and improving the heat dissipation effect. The air duct through which the cooling airflow flows is more finely separated by the flow guide assemblies, so as to form a ''rectifier''-like effect, thereby avoiding the situation that the cooling airflow forms turbulence among the densely arranged battery cells to affect the heat dissipation effect, further ensuring the heat dissipation effect of the cooling airflow on the battery cells, avoiding the service life and performance of materials such as polyanionic material from being affected by local overheating, and further ensuring the service life of the battery cell.

According to the large cylindrical sodium-ion battery cell energy storage device of the present disclosure, by arranging the clamping plates and the fins, the clamping plates can provide sufficient clamping force for the battery cell under the action of the compression springs. At the same time, the shape of the clamping plates enables the clamping plates to be tightly attached to the battery cell and provide sufficient contact pressure for the battery cell, thereby ensuring the stability of the installation of the battery cell. In addition, the clamping plates and the fins are made of the metal materials with the high thermal conductivity, so that the heat on the surface of the battery cell can be conducted out in time, and the heat dissipation effect of the battery cell is improved due to the fact that the heat dissipation area is greatly increased. At the same time, the adjacent groups of fins abut against each other to separate the air duct through which the cooling airflow flows, so as to forms a ''rectifier''-like effect, thereby avoiding the formation of turbulence, further ensuring the heat dissipation effect of the cooling airflow on the battery cell, and further ensuring the service life of the battery cell.

According to the large cylindrical sodium-ion battery cell energy storage device of the present disclosure, by arranging the filling layers, the ends of the fins can be protected, so as to avoid hard contact between the adjacent groups of fins and reduce the wear of the fins, thereby ensuring the service life of the fins;. On the other hand, because the filling layers are made of the flexible material, when the adjacent groups of fins abut against each other, the filling layers may be more tightly attached, thereby avoiding the gap in the gas flow channel formed by the separation of the plurality of groups of fins and further ensuring the stability of the cooling gas flow.

According to the large cylindrical sodium-ion battery cell energy storage device of the present disclosure, internal parts are easily loosen due to the susceptibility to bumps during transportation, and during the process of charging and discharging the battery cell, the battery cell generates heat and undergoes thermal expansion and contraction, which may easily cause the internal parts to displace slightly, thereby generating vibrations and affecting the normal use of the battery cell. According to the present solution, by arranging the clamping assemblies and the filling layers, the clamping plates and the compression springs are used to provide the clamping force for the battery cell, and the elasticity and the flexibility of the springs are used to compensate the possible displacement of the battery cell during the use process. In addition, the arrangement of the flexible materials of the compression springs and the filling layers may provide a certain buffer capacity for the battery cell, so that the use safety of the battery cell is improved, and the service life of the battery cell is ensured.

### BRIEF DESCRIPTION OF THE DRAWINGS

FIG. 1 is a schematic diagram of an overall structure of a box body of the present disclosure.

FIG. 2 is a schematic structural diagram of inside of a box body of the present disclosure.

FIG. 3 is a schematic structural diagram of arrangement and installation positions of battery cells of the present disclosure.

FIG. 4 is a schematic structural diagram of a positional relationship of a clamping assembly between a battery cell and a positioning sleeve of the present disclosure.

FIG. 5 is a schematic structural diagram of a positioning sleeve of the present disclosure.

FIG. 6 is a schematic diagram of an overall structure of a clamping assembly and a flow guide assembly of the present disclosure.

FIG. 7 is a schematic structural diagram of an area where a triangular blind area is located of the present disclosure.

FIG. 8 is a state diagram showing cooling gas being blown toward a triangular blind area through an air channel in the present disclosure.

FIG. 9 is a schematic structural diagram of a through hole and a plug of the present disclosure.

In the figures: 1. Box body; 2. Battery cell; 3. Air cooling mechanism; 4. Upper shell; 401. Upper mounting groove; 402. Upper air vent; 5. Lower shell; 501. Lower mounting groove; 502. Lower air vent; 6. Positioning sleeve; 601. Sliding groove; 602. Through groove; 7. Clamping assembly; 701. Clamping plate; 702. Limiting rod; 703. Compression spring; 8. Flow guide assembly; 801. Fin; 802. Filling layer; 9. Air channel; 10. Air port 1; 11. Air port 2; 12. Through hole; 13. Plug.

The technical solutions in the embodiments of the present disclosure will be clearly and completely described in conjunction with the drawings in the embodiments of the present disclosure. It is apparent that the described embodiments are only a part of the embodiments of the present disclosure, and not all of them. All other embodiments obtained by those of ordinary skill in the art based on the embodiments of the present disclosure without creative efforts are within the scope of protection of the present disclosure.

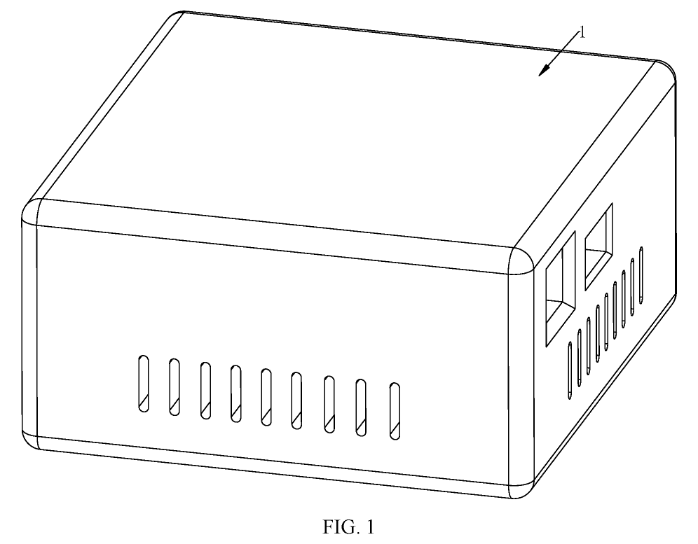

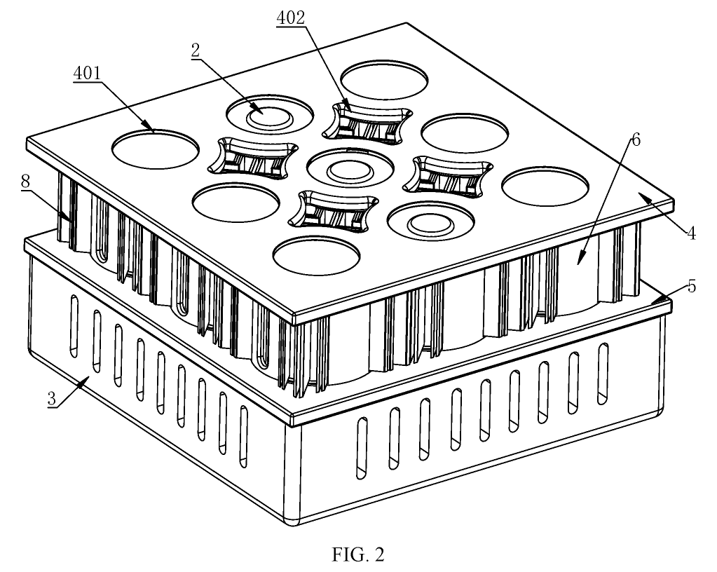

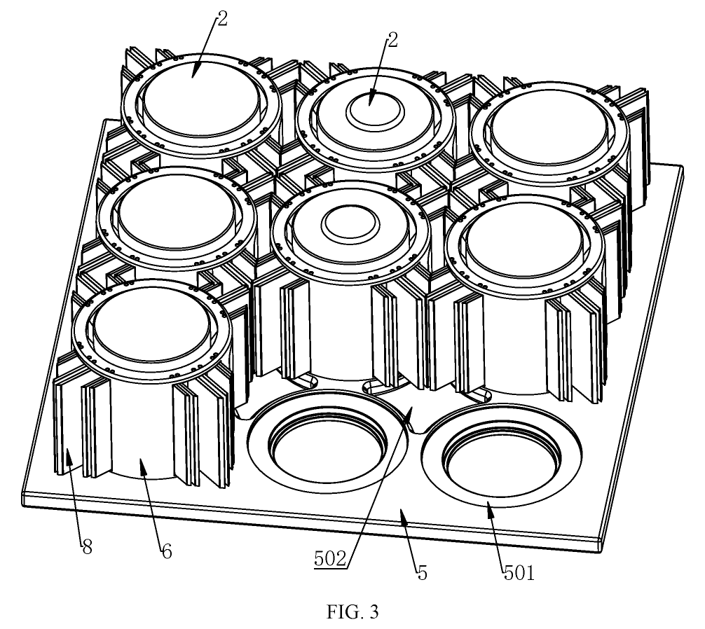

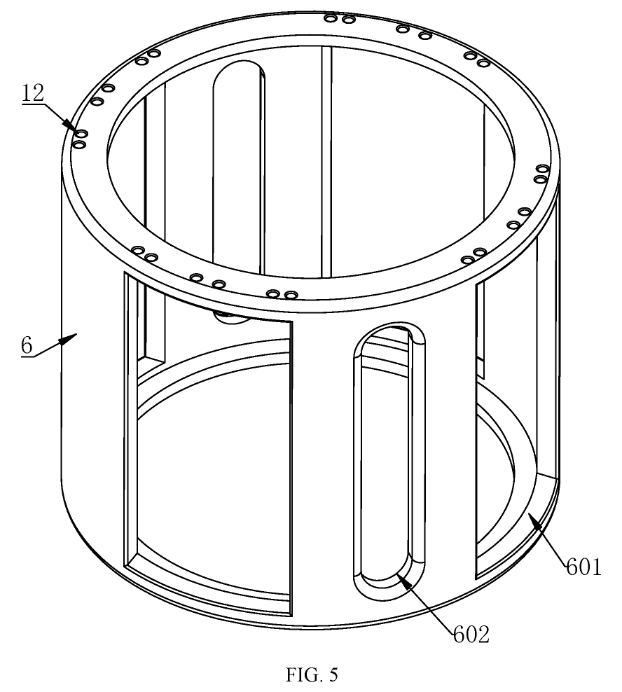

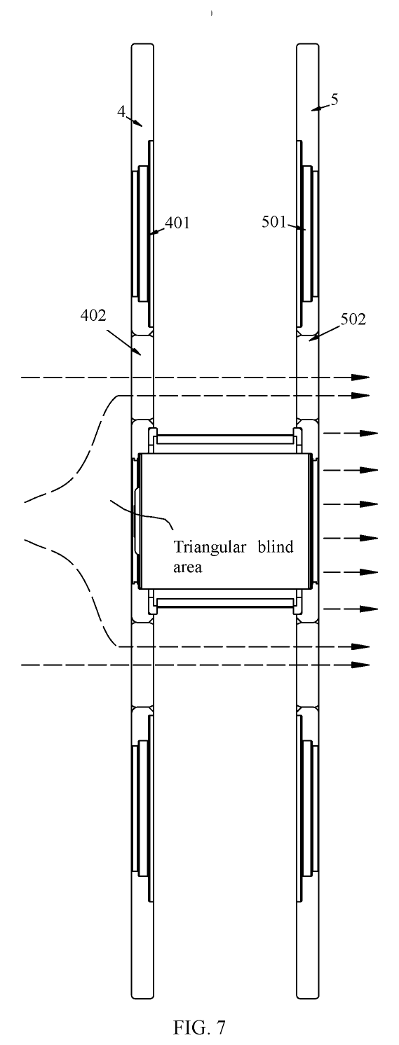

Referring to FIGS. 1-9, the present disclosure provides a large cylindrical sodium-ion battery cell energy storage device, and the technical solution is as follows.

Specifically, referring to FIGS. 1-3, a large cylindrical sodium-ion battery cell energy storage device includes a box body 1, battery cells 2 and an air cooling mechanism 3. A surface of the box body 1 is provided with a socket for connecting a charging or discharging connector, a side surface of the box body 1 is further provided with a slot for the air cooling mechanism 3 to draw air, and a filter screen for filtering impurities in the air is arranged in the slot. The battery cell 2 is cylindrical and made of polyanionic material. The air cooling mechanism 3 is of an air extraction type. The large cylindrical sodium-ion battery cell energy storage device further includes an upper shell 4, a lower shell 5, positioning sleeves 6, clamping assemblies 7, and flow guide assemblies 8. The upper shell 4 and the lower shell 5 are both arranged in the box body 1, the upper shell 4 is provided with a plurality of upper mounting grooves 401, the lower shell 5 is provided with a plurality of lower mounting grooves 501, and the upper mounting groove 401 and the lower mounting groove 501 are circular in overall shape, and can be installed and fixed in cooperation with the cylindrical battery cell 2.

An upper air vent 402 is formed among every four of the upper mounting grooves 401, and a lower air vent 502 is formed among every four of the lower mounting grooves 501. The hot air generated by the battery cell 2 moves upward, that is, flows out from the upper air vent 402, but the natural flow speed thereof is slow, which easily causes local heat rise. In this solution, the air cooling mechanism 3 is arranged below the lower air vent 502, and the air is extracted below the lower air vent 502, the airflow with lower external temperature is drawn in from the upper air vent 402, then flows through an air duct among the plurality of groups of battery cells 2, and is finally discharged from the lower air vent 502, so that the cooling airflow first cools down the area with higher temperature, thereby ensuring the uniformity of the surface temperature of the battery cell 2. While cooling the battery cell 2, the outflow of the hot air between the battery cells 2 is also accelerated. An upper side edge of the upper air vent 402 is provided with an arc chamfer, which can enable the airflow to flow more smoothly, and an air duct through which the cooling air flows is formed between the lower air vent 502 and the upper air vent 402.

The positioning sleeves 6 are arranged between the upper shell 4 and the lower shell 5, both ends of the positioning sleeve 6 are respectively connected to the upper mounting groove 401 and the lower mounting groove 501, and the plurality of battery cells 2 are arranged between the upper shell 4 and the lower shell 5. When the battery cell 2 is installed, it is only necessary to insert the battery cell 2 into the positioning sleeve 6 to achieve fixation. The plurality of clamping assemblies 7 are connected to the positioning sleeve 6. The flow guide assembly 8 is connected to the clamping assembly 7. After the battery cell 2 is inserted into the positioning sleeve 6, the clamping assemblies 7 provide a certain degree of clamping force for the battery cell, thereby improving the stability of the installation of the battery cell 2. On the other hand, the clamping assembly 7 can transfer the heat generated by the battery cell 2 to the flow guide assembly 8, and the heat dissipation area is increased through the flow guide assembly 8 to improve the heat dissipation effect. The plurality of clamping assemblies 7 move in a direction away from a central axis of the positioning sleeve 6, and drive the flow guide assemblies 8 to move into the air duct formed between the upper air vent 402 and the lower air vent 502, so that the cooling air directly acts on the surface of the flow guide assembly 8 to improve the heat dissipation effect. The adjacent guide assemblies 8 abut against each other to separate the air duct into a plurality of channels, so as to form a ''rectifier'' -like effect to avoid the formation of turbulence, which not only ensures the heat dissipation effect, but also can compress the cross-sectional area of a fluid flow path, thereby accelerating the fluid flow, improving the heat dissipation effect, and ensuring the service life of the battery cell 2.

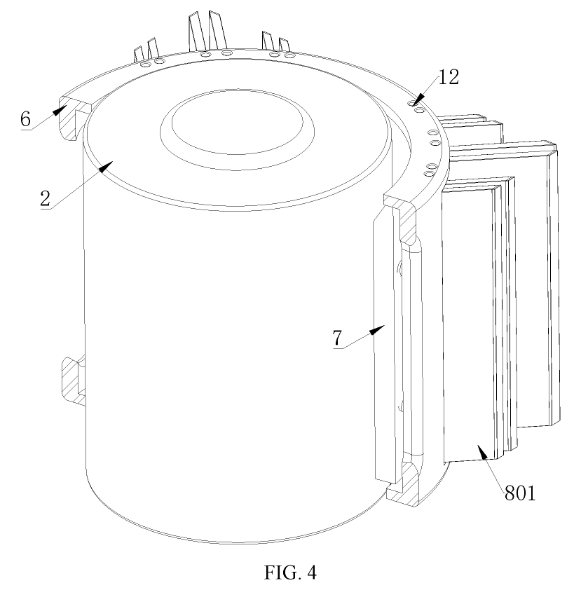

As an implementation of the present disclosure, referring to FIGS. 4-6, a side wall of the positioning sleeve 6 is provided with a plurality of through grooves 602, the through grooves 602 are in a rounded rectangular shape, and the through groove 602 is located between every two sliding grooves 601, and is configured to increase the communication space between the inside and the outside of the positioning sleeve 6, and increase the exposed surface area of the side wall of the battery cell 2, thereby ensuring the heat dissipation effect. The side wall of the positioning sleeve 6 is provided with a plurality of sliding grooves 601, and the clamping assembly 7 is connected to the sliding groove 601.

The clamping assembly 7 includes a clamping plate 701, a limiting rod 702, and a compression spring 703. The limiting rod 702 is connected to the positioning sleeve 6, and the clamping plate 701 is connected to the limiting rod 702. The clamping plate 701 is an arc plate, the shape of which can adapt well to an arc surface of a side surface of the battery cell 2, thereby maximizing the contact area, improving the heat dissipation effect, ensuring the operating temperature of the battery cell 2, and reducing the risk of thermal runaway. The clamping plate 701 is made of an aluminum plate, which can quickly transfer the heat generated by the battery cell 2 due to high thermal conductivity and has the characteristics of easiness in machining. At the same time, the shape of the clamping plate 703 enables the clamping plate to provide sufficient contact pressure for the battery cell 2, thereby ensuring the stability of the installation of the battery cell 2. The compression spring 703 is sleeved on the limiting rod 702 and both ends thereof are respectively connected to the clamping plate 701 and the positioning sleeve 6, and an upper end of the clamping plate 701 is provided with an inclined surface. During the process of inserting the battery cell 2 into the positioning sleeve 6, the battery cell 2 pushes the clamping plate 701 to move through the inclined surface at the upper end of the clamping plate 701. At the same time, the clamping plate 701 provides a certain clamping force for the battery cell 2 under the action of the compression spring 703, thereby ensuring the stability of the installation of the battery cell 2 and improving the use safety of the battery cell 2.

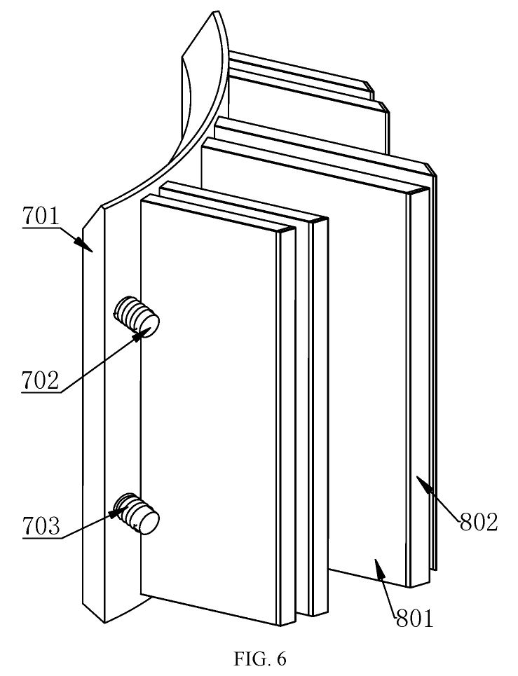

As an implementation of the present disclosure, referring to FIG. 6, the flow guide assembly 8 includes fins 801. The heat dissipation area is increased by the fins 801, and the fins 801 are made of the same material as the clamping plate 701, both being made of aluminum plates, so that the fins can absorb the heat of the clamping plate 701 well, and the fins 801 are located in the flow path of the cooling airflow so as to dissipate the surface heat in time and ensure the heat dissipation effect thereof. The plurality of fins 801 are connected to the clamping plate 701, ends of the fins 801 away from the clamping plate 701 are all provided with inclined surfaces, and the inclined surfaces at the ends of the fins 801 between the adjacent battery cells 2 can cooperate with each other, that is, can be tightly attached together to separate the air duct through which the cooling airflow flows into the plurality of channels with smaller cross-sectional areas, so as to form a ''rectifier''-like effect, thereby avoiding the formation of turbulence, enabling the cooling airflow to form the more stable airflow between the battery cells 2, and ensuring the heat dissipation effect of the cooling airflow on the battery cells 2. After the plurality of fins 801 abut against each other, the cross-sectional areas of the plurality of channels after separation are reduced, thereby compressing the cross-sectional area of the fluid flow path, accelerating the fluid flow, further improving the heat dissipation effect, and ensuring the service life of the battery cell 2.

The flow guide assembly 8 further includes filling layers 802. The filling layers 802 coat the ends of the fins 801, and the filling layers 802 are made of a rubber material, which has a certain buffering capacity, so as to avoid hard contact between the adjacent groups of fins 801, thereby reducing wear. In addition, the flexible material enables the fins to be tightly attached, so that there is no gap at an abutment position between the fins 801, thereby enabling the gas flow to be more stable.

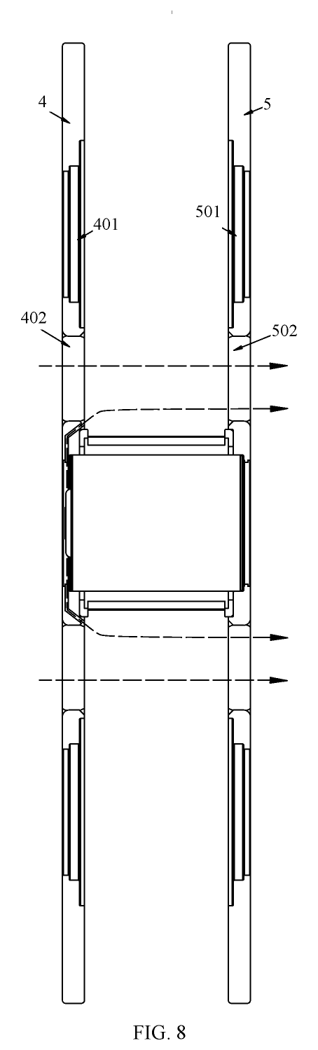

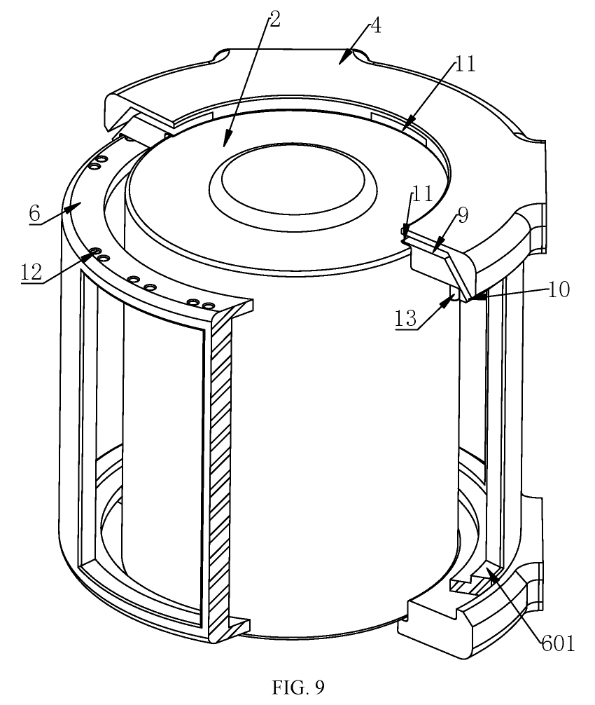

As an implementation of the present disclosure, referring to FIGS. 8-9, the upper shell 4 is provided with a plurality of air channels 9, both ends of the air channel 9 are respectively provided with an air port 110 and an air port 211, the air channel 9, the air port 10, and the air port 211 are all square, the air port 110 is located at the upper air vent 402, an opening of the air port 110 is inclined downward, the air port 211 is located at the upper mounting groove 401, and an orientation of the air port 211 is horizontal, so that the orientation of the air port 211 can conveniently guide the airflow in the area where the triangular blind area is located into the air channel 9, while the orientation of the air port 110 can conveniently guide the airflow into the air duct between the upper air vent 402 and the lower air vent 502, thereby accelerating the gas flow in the area where the triangular blind area is located, avoiding local overheating of the area where the triangular blind area is located, further ensuring the heat dissipation effect of the battery cell 2, and prolonging the service life of the battery cell 2.

As an implementation of the present disclosure, referring to FIG. 9, the positioning sleeve 6 is provided with a plurality of through holes 12, opening positions and the number of the through holes 12 correspond to the fins 801, a plurality of plugs 13 are arranged below the upper shell 4, and ends of the plugs 13 are made of a rubber material. When the upper shell 4 covers, the plugs 13 may be inserted into the through holes 12 and in contact with the fins 801 through rubber at the ends thereof, thereby increasing the friction to ensure the stability of the positions of the fins 801.

The specific working principle is as follows: during the installation process of the battery cell 2, the battery cell 2 first needs to be inserted into the positioning sleeve 6. During this process, the battery cell 2 extrudes the clamping assembly 7 to drive the flow guide assembly 8 to move, and the flow guide assembly 8 is directly exposed to the air duct through which the cooling airflow flows, so that the cooling airflow directly acts on the surface of the flow guide assembly 8, thereby improving the heat dissipation effect thereof.

Specifically, during the process of inserting the battery cell 2 into the positioning sleeve 6, the battery cell 2 is first in contact with the inclined surface at the upper end of the clamping plate 701. During the process of inserting the battery cell 2 downward, the clamping plate 701 is pushed outward by the above inclined surface. At the same time, under the action of the compression spring 703, the clamping plate 701 provides a certain degree of clamping force for the battery cell 2, thereby ensuring the stability of the installation of the battery cell 2. During the process of the clamping plate 701 moving outward, the fins 801 are driven to move into the air duct through which the cooling airflow flows. When the battery cell 2 is inserted and charged and discharged, the battery cell 2 continues to generate heat, and this heat may be absorbed by the clamping plate 701 and transferred to the fins 801 also having the high thermal conductivity. At this time, the fins 801 are in the flow path of the cooling airflow to be in direct contact with the cooling airflow, thereby accelerating the heat dissipation rate, and improving the heat dissipation effect thereof.

When the adjacent groups of flow guide assemblies 8 move into the air duct through which the cooling gas flows, they may form an abutment relationship with each other, and separate the air duct through which the cooling gas flows into the plurality of channels with smaller cross-sectional areas, so as to form a ''rectifier''-like effect, thereby avoiding the formation of turbulence in the flow process of the cooling gas between the battery cells 2, and ensuring the flow stability of the cooling gas and the cooling and heat dissipation effect on the battery cells 2.

Specifically, when the clamping plate 701 pushes the fins 801 to move, the adjacent groups of fins 801 may approach each other, and since the ends of the fins 801 are provided with the inclined surfaces that can cooperate with each other, when the fins 801 approach and abut against each other, the air duct through which the cooling gas flows is separated into the plurality of channels with smaller cross-sectional areas, thereby avoiding the formation of turbulence. In addition, the ends of the fins 801 are also coated with the filling layers 802, which can avoid hard contact between the adjacent groups of fins 801, thereby reducing the wear of the fins 801 and prolonging the service life thereof. On the other hand, the filling layer 802 may also fill the small gaps that are easily present in the abutting position between the fins 801, thereby enabling the flow of the cooling gas to be more stable and ensuring the heat dissipation effect thereof on the battery cell 2.

In order to avoid the triangular blind area from affecting the heat dissipation effect of the battery cell 2, the air channel 9, the air port 110, and the air port 211 are further provided. When the air cooling mechanism 3 draws air with lower external temperature from top to bottom, the orientation of the air port 211 can conveniently guide the airflow in the area where the triangular blind area is located into the air channel 9, while the orientation of the air port 110 can conveniently guide the airflow into the air duct between the upper air vent 402 and the lower air vent 502, thereby accelerating the gas flow in the area where the triangular blind area is located, cooling the area, avoiding local overheating, further ensuring the heat dissipation effect of the battery cell 2, and prolonging the service life of the battery cell 2.

Although the embodiments of the present disclosure have been shown and described, those of ordinary skill in the art may understand that various changes, modifications, substitutions and variations may be made to these embodiments without departing from the principle and spirit of the present disclosure, and the scope of the present disclosure is defined by the claims and their equivalents.

What is claimed is:

1. A large cylindrical sodium-ion battery cell energy storage device, comprising a box body, a plurality of battery cells, an air cooling mechanism, an upper shell, a lower shell, positioning sleeves, a plurality of clamping assemblies, and flow guide assemblies, wherein the upper shell and the lower shell are arranged in the box body, the upper shell is provided with a plurality of upper mounting grooves, and the lower shell is provided with a plurality of lower mounting grooves; an upper air vent is formed among every four upper mounting grooves of the plurality of upper mounting grooves, a lower air vent is formed among every four lower mounting grooves of the plurality of lower mounting grooves, and an air duct is formed between the lower air vent and the upper air vent, wherein cooling airflow flows through the air duct; the plurality of battery cells are arranged between the upper shell and the lower shell; the positioning sleeves are arranged between the upper shell and the lower shell; the plurality of clamping assemblies are connected to the positioning sleeve; the flow guide assembly is connected to the clamping assembly; the battery cell is inserted into the positioning sleeve and clamped by the plurality of clamping assemblies; the plurality of clamping assemblies move in a direction away from a central axis of the positioning sleeve, and drive the flow guide assemblies to move into the air duct formed between the upper air vent and the lower air vent; and adjacent flow guide assemblies abut against each other to separate the air duct into a plurality of channels.

2. The large cylindrical sodium-ion battery cell energy storage device according to claim 1, wherein the lower air vent is located above the air cooling mechanism, and an upper side edge of the upper air vent is provided with an arc chamfer.

3. The large cylindrical sodium-ion battery cell energy storage device according to claim 1, wherein a side wall of each of the positioning sleeves is provided with a plurality of sliding grooves; the clamping assembly is connected to the sliding groove; the clamping assembly comprises a clamping plate, a limiting rod and a compression spring, wherein the limiting rod is connected to the positioning sleeve, the clamping plate is connected to the limiting rod, and the compression spring is sleeved on the limiting rod and both ends of the compression spring are respectively connected to the clamping plate and the positioning sleeve; and an upper end of the clamping plate is provided with an inclined surface.

4. The large cylindrical sodium-ion battery cell energy storage device according to claim 3, wherein the clamping plate is an arc plate, and the clamping plate is made of a first metal material with a first high thermal conductivity.

5. The large cylindrical sodium-ion battery cell energy storage device according to claim 3, wherein the side wall of each of the positioning sleeves is provided with a plurality of through grooves, and each of the plurality of through grooves is located between every two sliding grooves of the plurality of sliding grooves.

6. The large cylindrical sodium-ion battery cell energy storage device according to claim 4, wherein each of the flow guide assemblies comprises a plurality of fins, wherein the plurality of fins are connected to the clamping plate, and the plurality of fins are made of a second metal material with a second high thermal conductivity.

7. The large cylindrical sodium-ion battery cell energy storage device according to claim 6, wherein ends of the plurality of fins away from the clamping plate are all provided with inclined surfaces, and the ends of the plurality of fins between adjacent battery cells cooperate with each other.

8. The large cylindrical sodium-ion battery cell energy storage device according to claim 7, wherein each of the flow guide assemblies further comprises filling layers, wherein the filling layers coat the ends of the plurality of fins, and the filling layers are made of a flexible material.

9. The large cylindrical sodium-ion battery cell energy storage device according to claim 1, wherein the upper shell is provided with a plurality of air channels, both ends of each of the plurality of air channels are respectively provided with a first air port and a second air port, the first air port is located at the upper air vent, an opening of the first air port is inclined downward, the second air port is located at the upper mounting groove, and an orientation of the second air port is horizontal.

10. The large cylindrical sodium-ion battery cell energy storage device according to claim 6, wherein each of the positioning sleeves is provided with a plurality of through holes, opening positions of the plurality of through holes correspond to the plurality of fins, a plurality of plugs are arranged below the upper shell, and ends of the plurality of plugs are made of a rubber material.
